(19) United States
(12) Patent Application Publication
(10) Pub. No.: US 2015/0031424 A1
(43) Pub. Date: Jan. 29, 2015

(54) STRATEGY GAME WITH TWO- OR THREE-DIMENSIONAL MATRIX AND DISCS OR BALLS AND METHOD OF PLAYING THEREOF

(71) Applicants: Dharmik M. Shroff, Austin, TX (US); Parth M. Shroff, Austin, TX (US)

(72) Inventors: Dharmik M. Shroff, Austin, TX (US); Parth M. Shroff, Austin, TX (US)

(21) Appl. No.: 13/950,425

(22) Filed: Jul. 25, 2013

(51) Int. Cl. A63F 13/822; A63F 3/00

(52) U.S. Cl. CPC A63F 13/822; A63F 3/00094; A63F 3/00214; A63F 2003/00223
USPC 463/9; 273/271

(57) ABSTRACT

A strategy game, and a method of playing said strategy game, comprising a board including a matrix, a first set of pieces, and a second set of pieces differing from the first set of pieces by an attribute such as color, wherein, a first plurality of the first set of pieces are placed in the matrix, the first plurality of the second set of pieces are placed in the matrix, and a winning position is determined when a second plurality of the first or second set of pieces are placed in a continuous line in the matrix, with the second plurality greater than the first plurality. The pieces may be placed in adjacent or non-adjacent positions in the matrix. In a particular embodiment, the second plurality is greater than the first plurality by at least three.

### FIELD OF THE DISCLOSURE

This invention generally relates to the field of strategy games, and in particular, to a method of playing a strategy game.

### BACKGROUND

Connect Four is an example of a two-player strategy game in which the players first choose a color and then take turns dropping colored discs from the top into a seven-column, six-row vertically-suspended matrix. The pieces fall straight down, occupying the lowest unoccupied space within the column. The object of the game is to connect four of one's own discs of the same color next to each other vertically, horizontally, or diagonally before one's opponent. There may be many variations on the matrix size, including 7×6, 8×7, 9×7, 10×7, and others.

It is a primary object of the present invention to provide a novel and unique method of playing a two-player strategy game on a matrix.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates an exemplary two-dimensional matrix for a strategy game with two pieces placed in the matrix by the first player in accordance with a specific embodiment of the present invention;

FIG. 2 illustrates the matrix shown in FIG. 1 for a strategy game with two pieces placed in the matrix by the second player subsequently to the play made by the first player;

FIG. 3 illustrates the matrix shown in FIG. 2 with a number of moves made by both players;

FIG. 4 illustrates the matrix shown in FIG. 2 with a number of moves made by both players;

FIG. 5 illustrates the matrix shown in FIG. 2 with a number of moves made by both players;

FIG. 6 illustrates an exemplary three-dimensional matrix for a strategy game in accordance with a specific embodiment of the present invention;

FIG. 7 illustrates an example of an electronic apparatus for a strategy game in accordance with a specific embodiment of the present invention;

FIG. 8 is a flow-diagram illustrating an exemplary method of playing a strategy game in accordance with a specific embodiment of the present disclosure; and

FIG. 9 is a block diagram of a processing system in accordance with a specific embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications.

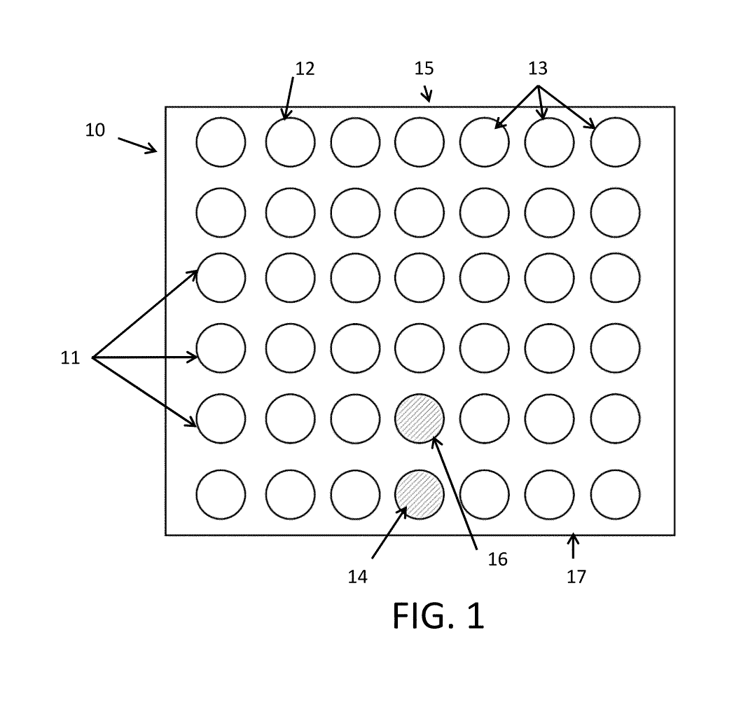

Shown in FIG. 1 is an exemplary matrix 10 for a two-player strategy game with a plurality of rows 11 and columns 13 comprising of a plurality of positions 12 for placing pieces. In a particular embodiment, the matrix 10 may be a grid positioned vertically to have a top 15 and a bottom 17 and game pieces may be dropped into the columns, where the game pieces are drawn by gravity into the bottom-most free position. In an exemplary embodiment, matrix 10 may have 7 columns and 6 rows. Placed in the matrix 10 are two game pieces 14 and 16, representing moves made by the first player. In this representation, the pieces are shown to be placed adjacent to each other, however, they may be placed in non-adjacent positions in the matrix. In a particular embodiment, two discs are placed by the first player into a Connect Four board by dropping them to the bottom of the matrix. The game proceeds with each player placing two pieces, with the object to place five pieces in a line, either horizontally, vertically, or diagonally.

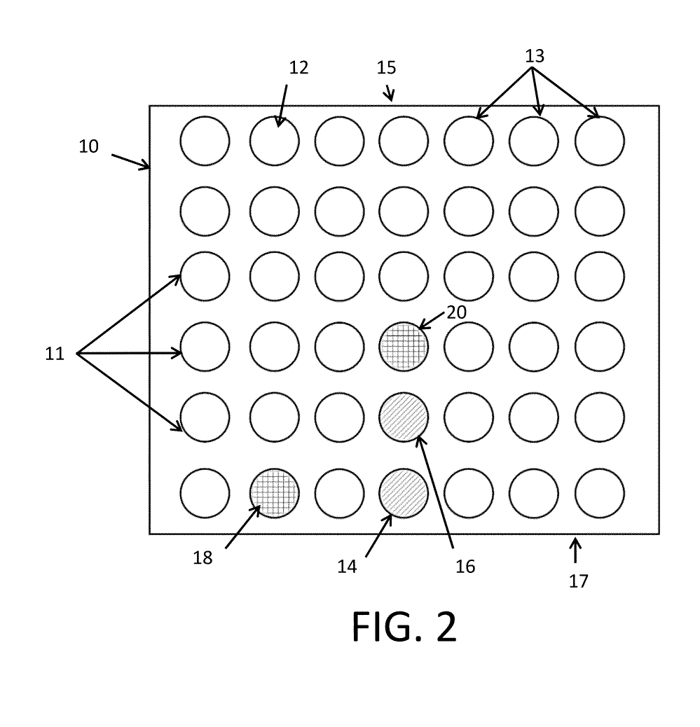

Shown in FIG. 2 is the matrix of FIG. 1, with two pieces 18 and 20 placed by a second player following the move made by the first player as shown in FIG. 1. In the particular embodiment using a Connect Four board, the pieces may be dropped into available empty slots in the matrix.

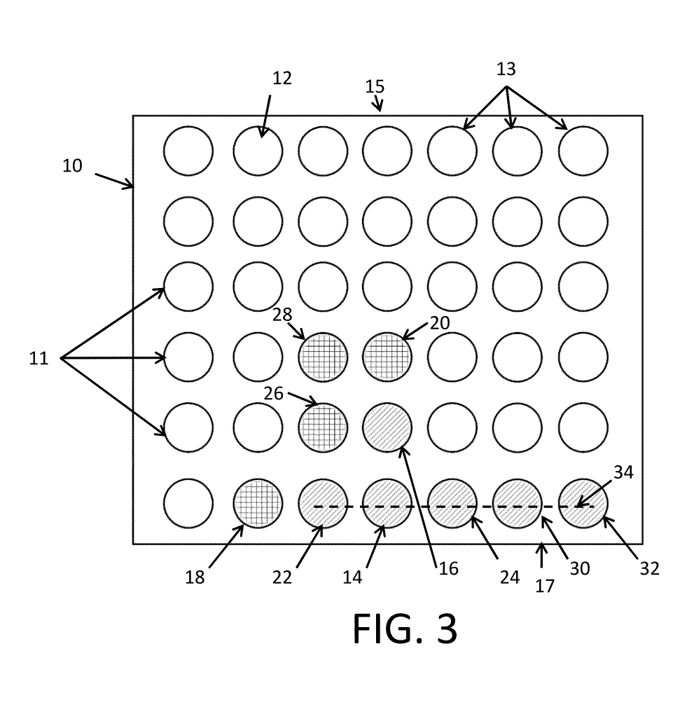

Shown in FIG. 3 is the matrix of FIG. 2, showing a game play where the first player has successfully placed 5 pieces in a row. Here, pieces 22 and 24 are placed by the first player, followed by pieces 26 and 28 placed by the second player, and followed by pieces 30 and 32 placed by the first player. At this point, the first player has five pieces in a horizontal line 34 comprising, from left to right, pieces 22, 14, 24, 30, and 32, and is the winner of the game.

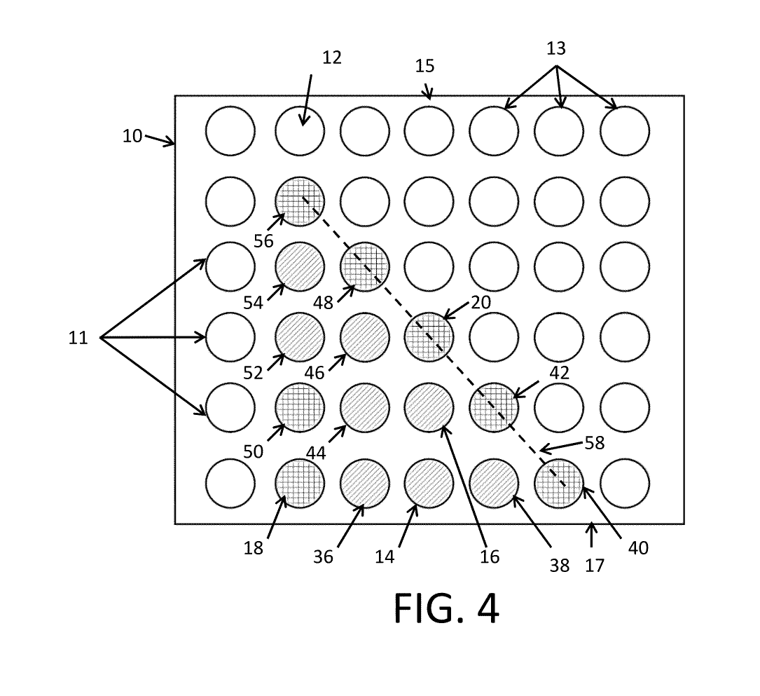

Shown in FIG. 4 is the matrix of FIG. 2, showing a game play where the second player has successfully placed 5 pieces in a row. Here, pieces 36 and 38 are placed by the first player, followed by pieces 40 and 42 placed by the second player, followed by pieces 44 and 46 placed by the first player, followed by pieces 48 and 50 placed by the second player, followed by pieces 52 and 54 placed by the first player, and finally, piece 56 placed by the second player. At this point, the second player has five pieces in a diagonal line 58, comprising from bottom right to top left, pieces 40, 42, 20, 48, and 56, and is the winner of the game.

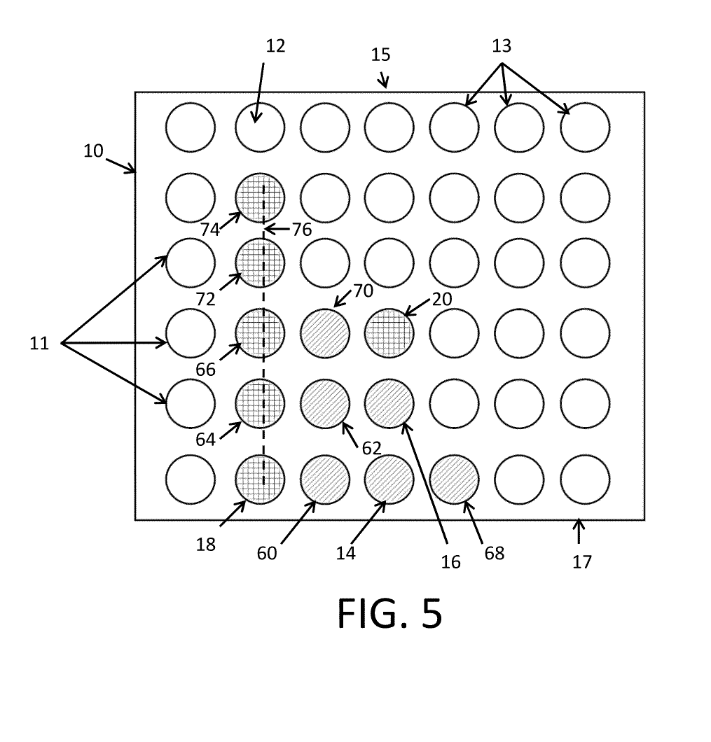

Shown in FIG. 5 is the matrix of FIG. 2, showing a game play where the first player has successfully placed 5 pieces in a row. Here, pieces 60 and 62 are placed by the first player, followed by pieces 64 and 66 placed by the second player, followed by pieces 68 and 70 placed by the first player, and followed by pieces 72 and 74 placed by the second player. At this point, the second player has five pieces in a vertical line 76, comprising from bottom to top, pieces 18, 64, 66, 72, and 74, and is the winner of the game.

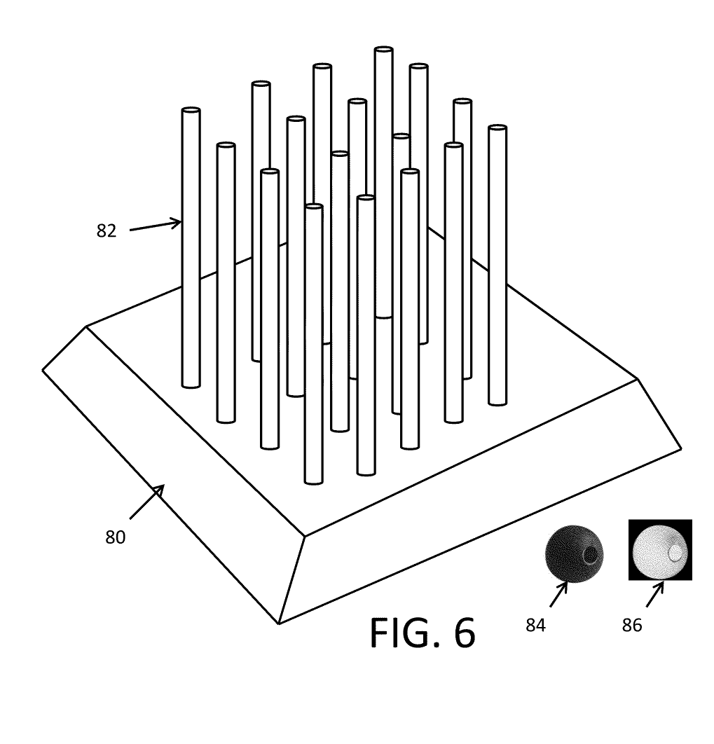

Shown in FIG. 6 is an exemplary matrix 80 to facilitate playing the game in three dimensions with a plurality of pegs 82 on the board to place pieces such as pieces 84 and 86. As previously described, each player plays two pieces in adjacent or non-adjacent locations on the pegs, and a player may win when he or she has five pieces in a straight line on any plane, level or angle. The straight line may be horizontal, vertical, or diagonal.

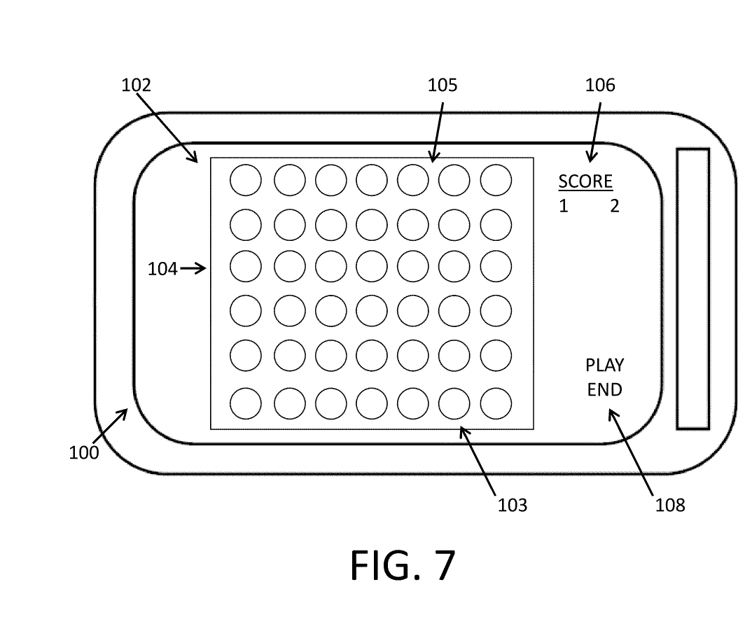

Shown in FIG. 7 is an illustrative embodiment to allow the game to be played electronically. In the embodiment shown, a smartphone 100 has an application 102 with a game board 104, score card 106, and selection panel 108. Application 102 may be an installed computer program or may be a widget downloaded from an application store. In some embodiments, game board 104 may have a bottom 103 and a top 105. The game may be played with an opponent in person or online, or with the computer as an opponent. The score card 106 allows the two players to keep track of their scores over a plurality of games, and selection panel 108 allows the player to initiate or terminate the game. In another embodiment, smartphone 100 may be replaced by a computer.

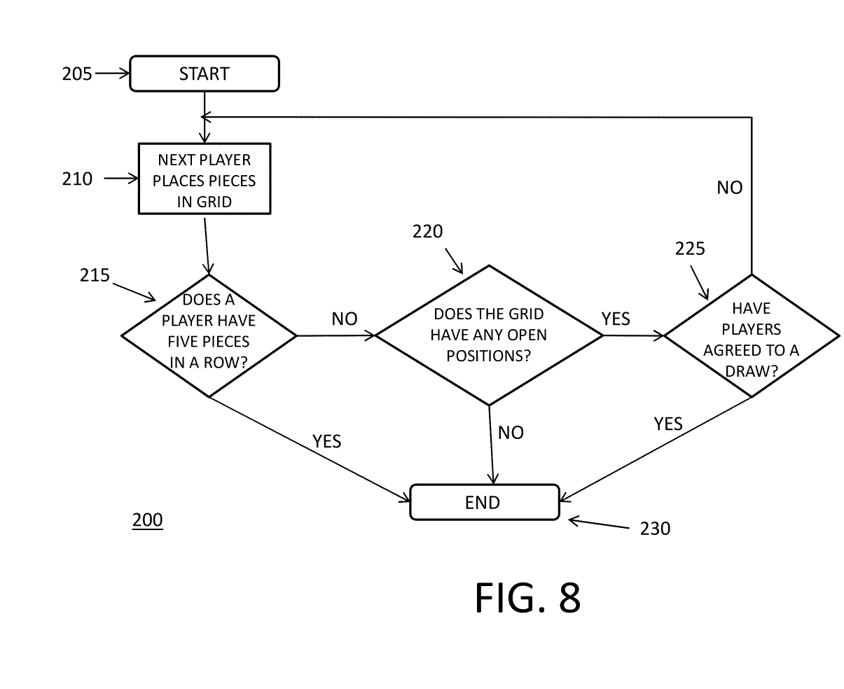

Shown in FIG. 8 is a flow-diagram 200 illustrating an exemplary method of playing the strategy game in accordance with a specific embodiment of the present disclosure. The game is initiated at start block 205. At block 210, two pieces of a first type are placed in the matrix by the next player. At the start of the game, block 210 would comprise of two pieces being played by the first player, followed by two pieces being played by the second player. Following a move by any player, the matrix is checked in decision diamond 215 to determine if the last player that played a move has five pieces in a line, either horizontally, vertically, or diagonally. If this is the case, the game ends at end block 230 with the player having five pieces in a line winning the game. If this is not the case, the game proceeds to decision diamond 220 to determine if there are any open positions left on the matrix. If there are no open positions, the game ends at end block 230 as a draw or tie. If there are open positions available, then the game proceeds to decision diamond 225 to determine if the players have agreed to a draw. If this is the case, the game ends at end block 230 as a draw or tie. If this is not the case, the method reverts back to block 210 in order to continue playing the game.

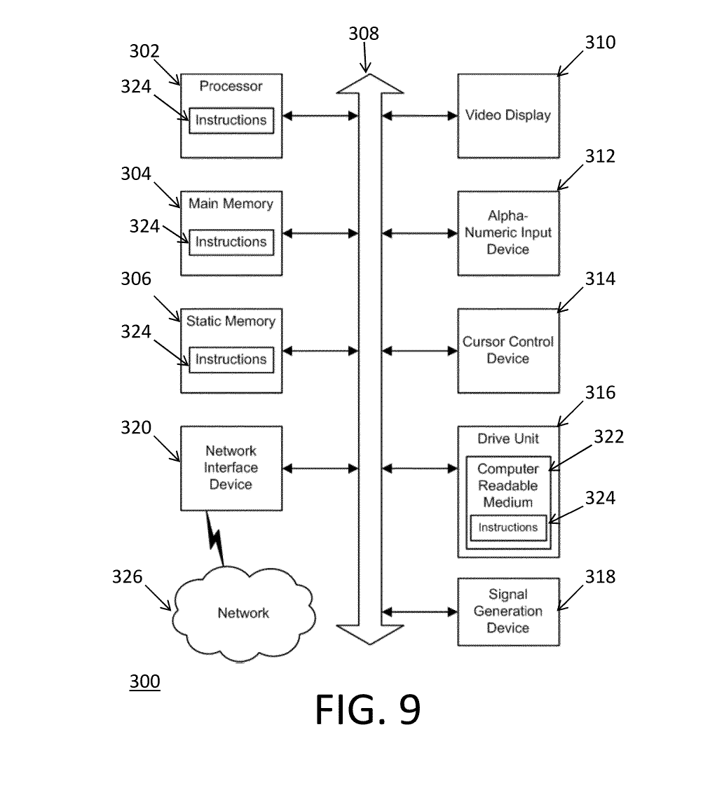

FIG. 9 is a block diagram of a data processing system 300 in accordance with at least one embodiment of the present disclosure. Processing system 300 can include a set of instructions that can be executed to manipulate processing system 300 to perform any one or more of the methods or functions disclosed above. Processing system 300 may operate as a standalone device or may be connected, e.g., using a network, to other processing systems or peripheral devices.

In a networked deployment, processing system 300 may operate in the capacity of a server or as a client user computer in a server-client user network environment, or as a peer processing system in a peer-to-peer (or distributed) network environment. Further, while a single processing system 300 is illustrated, the term “system” shall also be taken to include any collection of systems or sub-systems that individually or jointly execute a set, or multiple sets, of instructions to perform one or more computer functions.

Processing system 300 may include one or more processors 302, e.g., a central processing unit (CPU), a graphics processing unit (GPU), or both. Moreover, processing system 300 can include a main memory 304 and a static memory 306 that can communicate with each other via a bus 308. As shown, processing system 300 may further include a video display unit 310, such as a liquid crystal display (LCD), an organic light emitting diode (OLED), a flat panel display, a solid state display, or a cathode ray tube (CRT). Additionally, processing system 300 may include an alpha-numeric input device 312, such as a keyboard, and a cursor control device 314, such as a mouse. Processing system 300 can also include a disk drive unit 316, a signal generation device 318, such as a speaker, and a network interface device 320.

In a particular embodiment, disk drive unit 316 may include a computer readable medium 322 in which one or more sets of instructions 324, e.g. software, can be embedded. Further, instructions 324 may embody one or more of the methods or logic as described herein. In a particular embodiment, instructions 324 may reside completely, or at least partially, within main memory 304, static memory 306, and/or within processor 302 during execution by processing system 300. Main memory 304 and processor 302 also may include computer readable media. Network interface device 320 can provide connectivity to a network 326, e.g., a wide area network (WAN), a local area network (LAN), or other network.

In accordance with various embodiments of the present disclosure, the methods described herein may be implemented, in whole or in part, by software programs executable by processing system 300. The present disclosure contemplates a computer readable storage device (e.g., main memory 304, static memory 306, or drive unit 316) that includes instructions 324 or receives and provides instructions 324 for execution. Further data representative of an integrated circuit design can be stored in one or more of the computer readable storage devices for access by processing system 300 during execution of instructions 324 so as to implement the methods described above.

While the computer readable storage device is shown to be a single storage device, the term “computer readable storage device” includes a single storage device or multiple storage devices, such as a centralized or distributed database, and/or associated caches and servers that store one or more sets of instructions. The term “computer readable storage device” shall also include any storage device that is capable of storing a set of instructions for execution by a processor or that causes a processing system to perform any one or more of the methods or operations disclosed herein.

In a particular non-limiting, exemplary embodiment, the computer readable storage device can include a solid-state memory such as a memory card or other package that houses one or more non-volatile read-only memories. Further, the computer readable storage device can be a random access memory or other volatile re-writeable memory. Additionally, the computer readable storage device can include a magneto-optical or optical medium, such as a disk or tapes or other storage devices. A non-transitory computer readable storage device comprises all computer readable storage devices except for a transitory propagating signal.

In other embodiments, the game may be played with a different matrix size than the one illustrated in FIGS. 1-5. In a different embodiment, each player may place more than two pieces, and a player wins when a number of pieces of any one color or pattern greater than or equal to the number of pieces played plus three are placed in a line. For example, the game may be played by placing three pieces at a time, and a player wins when six pieces of any one color are placed in a line. In another embodiment, a player may, as an alternative to placing pieces in the matrix, remove pieces of his or her color or pattern from one or more sides of the matrix, in order to change the relationship among the pieces left on the matrix. As a further alternative, a player may use a combination of placing and removing pieces of his or her color or pattern on the matrix. In yet another embodiment, the player may lose if he or she gets the required number of pieces in a line in the matrix, but is unable to prevent only that number of pieces from being placed in a line. For example, if playing with two pieces at a time with the objective of placing five pieces of one's own color or pattern in a line, a player may lose if he or she places five pieces of his or her own color or pattern in a line, but is unable to prevent a sixth piece of one's own color from being placed in the same line. In yet another embodiment, the game may be played with the matrix being a flat grid, in a manner similar to Tic-Tac-Toe.

Although the invention is described herein with reference to specific embodiments, various modifications and changes can be made without departing from the scope of the present invention as set forth in the claims below. However, one of ordinary skill in the art appreciates that various modifications and changes can be made without departing from the scope of the present disclosure as set forth in the claims below. For example, the game may be played with more than two pieces played at each turn, and a player may win when more than five pieces line up. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A strategy game, comprising:
a board including a matrix;
a first set of pieces; and
a second set of pieces, differing from the first set of pieces by an attribute;
wherein:
a first plurality of the first set of pieces are placed in the matrix;
the first plurality of the second set of pieces are placed in the matrix, and
a winning position is determined when a second plurality of the first set of pieces are placed in a continuous line in the matrix; and
the second plurality is greater than the first plurality.

2. The game of claim 1, wherein the second plurality is greater than the first plurality by at least three.

3. The game of claim 2, wherein after the first plurality of the first set of pieces and the first plurality of the second set of pieces are placed in the matrix, and before the winning position is determined, the first plurality of the first set of pieces are placed in the matrix, and the first plurality of the second set of pieces are placed in the matrix.

4. The game of claim 3, wherein:
the pieces are placed at the lowest available position in a column in the matrix.
the board including the matrix is a Connect Four game; and
the continuous line is one of horizontal, vertical, or diagonal.

5. The game of claim 3, wherein:
the pieces are placed at the lowest available position in a column in the matrix.
the board including the matrix is a Score Four game; and
the continuous line is one of horizontal, vertical, or diagonal, in any plane.

6. The game of claim 3, wherein after the first plurality of the first set of pieces and the first plurality of the second set of pieces are placed in the matrix, a piece is removed from the game board.

7. The game of claim 6, wherein the pieces are removed from the lowest available position in a column in the matrix.

8. The game of claim 2, wherein the first plurality is two and the second plurality is five.

9. The game of claim 1, wherein:
a losing position is determined when a third plurality of the first set of piece pieces are placed in a continuous line in the matrix; and
the third plurality is greater than the second plurality.

10. A method, comprising:
placing a first plurality of a first set of pieces in a matrix of a game board;
placing the first plurality of a second set of pieces in the matrix wherein the first set of pieces differs from the second set of pieces by at least one attribute; and
determining a winning position when a second plurality of the first set of pieces are placed in a continuous line in the matrix, wherein the second plurality is greater than the first plurality.

11. The method of claim 10, wherein further the second plurality is greater than the first plurality by at least three.

12. The method of claim 11, wherein after placing the first plurality of the first set of pieces and placing the first plurality of the second set of pieces in the matrix, and before determining the winning position, the method further comprises:
placing a second time the first plurality of the first set of pieces in the matrix; and
placing a second time the first plurality of the second set of pieces in the matrix.

13. The method of claim 12, further comprising:
placing the pieces at the lowest available position in a column in the matrix;
wherein:
the board including the matrix is a Connect Four game; and
the continuous line is one of horizontal, vertical, or diagonal.

14. The method of claim 12, further comprising:
placing the pieces at the lowest available position in a column in the matrix;
wherein:
the board including the matrix is a Score Four game; and
the continuous line is one of horizontal, vertical, or diagonal, in any plane.

15. The game of claim 13, wherein after the first plurality of the first set of pieces and the first plurality of the second set of pieces are placed in the matrix, the method further comprises:
removing a piece from the lowest available position in a column in the matrix.

16. The game of claim 11, wherein further the first plurality being two and the second plurality being five.

17. A non-transitory computer-readable medium, including code for performing a method, the method comprising:
placing a first plurality of a first set of pieces in a matrix of a game board;
placing a first plurality of a first set of pieces in a matrix of a game board;
placing the first plurality of a second set of pieces in the matrix, wherein the first set of pieces differs from the second set of pieces by at least one attribute; and
determining a winning position when a second plurality of the first set of pieces are placed in a continuous line in the matrix, wherein the second plurality is greater than the first plurality.

18. The computer-readable medium of claim 17, wherein the second plurality is greater than the first plurality by at least three.

19. The computer-readable medium of claim 18, wherein, after placing the first plurality of the first set of pieces and placing the first plurality of the second set of pieces in the matrix, and before determining the winning position, the method further comprises;
placing the first plurality of the first set of pieces in the matrix, and placing the first plurality of the second set of pieces in the matrix.

20. The computer-readable medium of claim 19, the method further comprising:
placing the pieces at the lowest available position in a column in the matrix;
wherein:
the board including the matrix is a Connect Four game; and
the continuous line is one of horizontal, vertical, or diagonal.

21. The computer-readable medium of claim 20, wherein, after the first plurality of the first set of pieces and the first plurality of the second set of pieces are placed in the matrix, the method further comprises:
removing a piece from the lowest available position in a column in the matrix.

22. The computer-readable medium of claim 18, wherein further the first plurality being two and the second plurality being five.
